(19) United States
(12) Patent Application Publication
(10) Pub. No.: US 2001/0017713 A1
(43) Pub. Date: Aug. 30, 2001

(54) Portable printer

(75) Inventor: Akihiko Shinohara, Shibata-gun (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: TOHOKU RICOH CO., LTD., Shibata-gun (JP)

(21) Appl. No.: 09/791,898

(22) Filed: Feb. 26, 2001

(30) Foreign Application Priority Data
Feb. 28, 2000 (JP) 2000-104149
May 2, 2000 (JP) 2000-133076

(51) Int. Cl. B41B 1/00

(52) U.S. Cl. 358/1.15

(57) ABSTRACT

Since optical communication units are provided on different faces of an outer surface of a portable printer at two or more spots thereof for effecting optical transmission and reception of data between the portable printer and a data output device such as a handy terminal and a hand-held personal computer, optical transmission and reception of data between the portable printer and the data output device (host) can be effected with ease even if it is carried on a user's belt or placed on a desk, and the optical communication units provided at two or more spots may be mounted on a single printed-circuit board.

### BACKGROUND OF THE INVENTION

1. Field of the Invention

The invention relates to a portable printer for effecting optical transmission and reception of data between itself and a data output device such as a handy terminal (hereinafter referred to as HT), a hand-held personal computer (hereinafter referred to as HPC) and so forth, and for printing data on paper.

2. Description of the Related Art

A conventional portable printer has been designed on the assumption that it would be generally used while it would be mounted or carried on a user's waist or belt. If the portable printer is used while it is carried on a user's waist, an optical communication unit having a communication window for use in optical transmission/reception is provided on the upper portion thereof so as to effect optical communication with ease between itself and an HT.

There is a case where a portable printer of this type is used while it is placed on a desk. In such a case, suppose that a host serving as a data output device is an HPC, the HPC needs to be raised over the upper portion of the communication window attached to the upper portion of the portable printer so as to align an optical axis of the HPC with that of the communication window of the optical communication unit of the portable printer.

Since the communication window of the HPC is generally attached to the side face of the HPC, the HPC is raised so as to be positioned perpendicularly so that the side face of the HPC is put over the portable printer, which compels a user to be rendered inconvenient.

A shoulder holding or hanging type portable printer is disclosed in, for example, Japanese Patent Laid-Open Publication No. 8-300771, wherein a communication window is provided only on the upper surface thereof, which causes a drawback that it is inconvenient in use when placed on a desk.

The invention has been developed to solve the foregoing inconvenience and to provide a portable printer capable of effecting optical transmission and reception of data between itself and a data output device (host) even if it is carried on a user's waist or placed on a desk.

### SUMMARY OF THE INVENTION

To achieve the above object, the invention provides a portable printer provided with optical communication units for effecting optical transmission and reception of data between itself and a data output device such as an HT and an HPC, and printing data received by the optical communication units on paper, wherein the optical communication units are provided on different faces of an outer surface of the portable printer at two or more spots thereof.

With the portable printer having the foregoing construction, it can effect transmission and reception of data between itself and the data output device or host without operating it unnaturally by selectively using a plurality of optical communication units even if it is carried on a user's waist or placed on a desk.

Since a plurality of optical communication units are provided not only on one side of the portable printer but also on a plurality of sides thereof, transmission and reception of data can be effected between the portable printer and the host without concern for a positional relationship between the portable printer and the host by means of optical communication units.

Further, the optical communication units provided on the outer surface of the portable printer at two or more spots can be mounted on a single printed-circuit board.

Still further, it is preferable that the portable printer has optical communication unit control means for giving a priority to one optical communication unit which first received data among the optical communication units provided on the outer surface of the portable printer at two or more spots, then refusing data from remaining other optical communication units.

More still further, the portable printer may have optical communication unit control means which periodically subsequently switches the optical communication units provided on the outer surface of the portable printer at two or more spots so as to render only one optical communication unit in a state to receive data, and after either of the optical communication units received data, the optical communication unit control means renders the optical communication unit which received data in a state to receive data continuously.

It is preferable that the optical communication unit control means has power saving means for interrupting the supply of a power to the optical communication units other than one optical communication unit which is rendered in a state to receive data.

The above and other objects, features and advantages of the invention will be apparent from the following detailed description which is to be read in conjunction with the accompanying drawings.

### BRIEF DESCRIPTION OF THE DRAWINGS

FIG. 1 is a perspective view showing a state where a portable printer of the invention which is carried on a user's waist effects printing;

FIG. 2 is a perspective view showing a state where optical communication is effected between the portable printer shown in FIG. 1 which is carried on a user's waist and an HT;

FIG. 3 is a perspective view showing a state where optical communication is effected between the portable printer shown in FIG. 1 which is placed on a desk and an HPC;

FIG. 4 is a perspective view showing an external appearance of an optical communication unit used in the invention;

FIG. 5 is a plan view showing a case where three optical communication units are mounted on a single printed-circuit board;

FIG. 6 is a side view in FIG. 5;

FIG. 7 is an internal circuit diagram of the optical communication unit used in the invention; and

FIG. 8 is a block diagram showing the construction of an internal electronic circuit of the portable printer shown in FIG. 1.

### DETAILED DESCRIPTION OF THE PREFERRED EMBODIMENT

A preferred embodiment of the invention is now described with reference to the attached drawings.

FIG. 1 is a perspective view showing a portable printer according to a preferred embodiment of the invention, and it shows a state where the portable printer is carried on a user's waist.

The portable printer 1 shown in FIG. 1 includes a thermal print mechanism, a paper feed unit, a control circuit and so forth respectively provided inside a case 11, and also includes an operation section 12, a 5 paper eject port 13 for ejecting printed paper 10 and a communication window of a first optical communication unit 14 respectively provided on an outer upper surface of the case 11 (right face in a state shown in FIG. 1).

The portable printer 1 also includes a communication window of a second optical communication unit 15 provided on an outer side face (upper face in a state shown in FIG. 1). The portable printer 1 still also includes a communication window of a third optical communication unit 16 provided on an opposite side invisible in FIG. 1 (see FIG. 3).

A belt 17 is fixed to the bottom surface of the case 11 (left face in a state shown in FIG. 1), and it is wound around and fixed to a user's waist so that the portable printer 1 can be mounted on the user's waist.

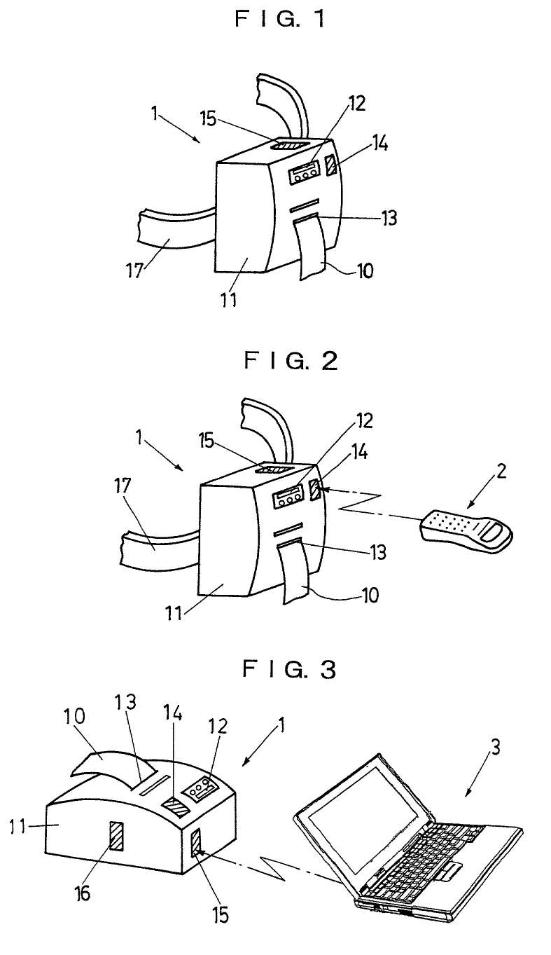

An example of use of the portable printer 1 is described now with reference to FIGS. 2 and 3.

FIG. 2 is a case where the portable printer 1 is used while it is mounted on a user's waist. In this case, if optical data is transmitted from a communication window (not shown) of an optical communication unit of an HT 2 toward a communication window of the first optical communication unit 14 provided on the upper surface of the portable printer 1 in a state where the HT 2 serving as a data output device is substantially horizontally positioned, the portable printer 1 receives the optical data at the first optical communication unit 14, prints characters, bar codes and so forth prepared on the basis of the received data on paper 10, and ejects the printed paper 10 from the paper eject port 13. Consequently, a bar code label, a price tag or card and so forth respectively to be pasted on merchandise can be prepared with ease.

FIG. 3 is a case where the portable printer 1 is used while it is placed on a desk, not shown. In this case, data prepared by an HPC 3 is transmitted as optical data from a communication window of an optical communication unit (not shown) provided on the rear face of the HPC 3 which is also placed on a desk toward the communication window of the second optical communication unit 15 provided on one of the side faces of the portable printer 1.

Consequently, data transmitted from the HPC 3 is received by the second optical communication unit 15 of the portable printer 1, and characters, bar codes and so forth prepared on the basis of the received data are printed on the paper 10, and the printed paper 10 is ejected from the paper eject port 13.

It is possible to effect optical communication using the third optical communication unit 16 of the portable printer 1 depending on the placement of the HPC 3.

As set forth in the forgoing, since the portable printer 1 according to the invention has the optical communication units provided on different faces of the case 11 at two or more spots such as on the upper face and side face of the outer surface of the case 11 (three spots according to the embodiment shown in FIG. 3), optical transmission and reception of data can be effected with ease without operating the data output device unnaturally such that the data output device is put over the portable printer 1 perpendicularly, by selectively using a plurality of optical communication units even if the portable printer 1 is carried on a user's waist or placed on a desk.

Further, transmission and reception of data between the portable printer 1 and the data output device (host) such as the HT 2 and the HPC 3 can be effected with ease without concern for a positional relationship between the portable printer 1 and the data output device by the provision of the optical communication units not only on one side face of the case 11 but also on a plurality of side faces of the case 11.

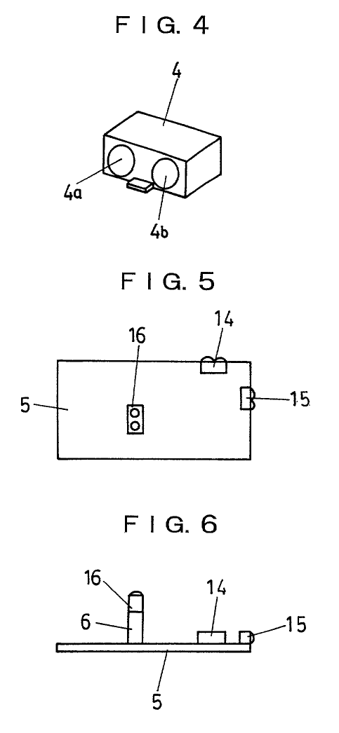

FIG. 4 is a perspective view of the optical communication unit where a transmission window 4a and a reception window 4b are provided on a front surface of a small rectangular parallelepiped housing 4. These two windows, i.e., the transmission window 4a and reception window 4b are generally called a communication window. The first optical communication unit 14, second optical communication unit 15 and third optical communication unit 16 shown in FIGS. 1 to 3 have the same construction as the optical communication unit shown in FIG. 4.

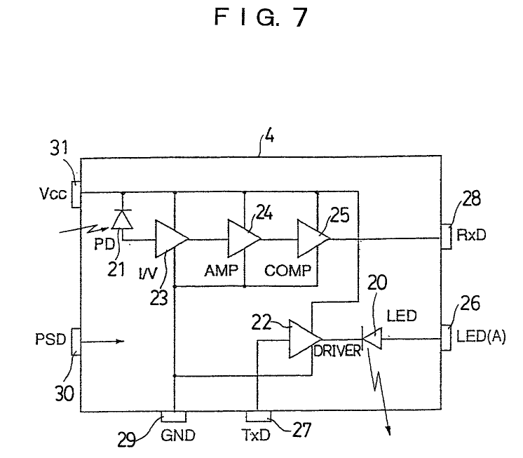

An internal circuit of this optical communication unit is constructed as shown in FIG. 7. A light-emitting diode (LED) 20 is provided inside the transmission window 4a shown in FIG. 4 while a photodiode 21 is provided inside the reception window 4b. Further, a driver 22, an inverter 23, an amplifier 24 and a comparator 25 are provided inside the housing 4 while an LED power supply terminal 26, a transmission data input terminal 27, a reception data output terminal 28, a ground terminal 29, a power control terminal 30 and a Vcc power supply terminal 31 are provided outside the housing 4.

When transmission data is inputted to the transmission data input terminal 27, the LED 20 emits light to output an optical signal in response to the transmission data. When the photodiode 21 receives the optical signal, it converts the optical signal into an electric signal and binarizes the electric signal, then outputs the binarized signal from the reception data output terminal 28. FIGS. 5 and 6 are a plan view and a side view respectively showing an example of mounting three optical communication units, namely, the first optical communication unit 14, second optical communication unit 15 and third optical communication unit 16. In this example, the three optical communication units 14, 15 and 16 are mounted on a single printed-circuit board (PCB) 5 provided inside the case 11 of the portable printer 1. The third optical communication unit 16 is mounted on the PCB 5 by way of an attachment table 6 so that it is adjusted in height by the attachment table 6. The first optical communication unit 14 and second optical communication unit 15 can use the attachment table 6 if the heights thereof need to be adjusted.

Since the plurality of optical communication units 14, 15 and 16 are mounted on the single PCB 5, not only extra PCBs but also cables for connecting such extra PCBs can be dispensed with in comparison with a case where a plurality of optical communication units are mounted on individual PCBs, thereby lowering the cost of the portable printer.

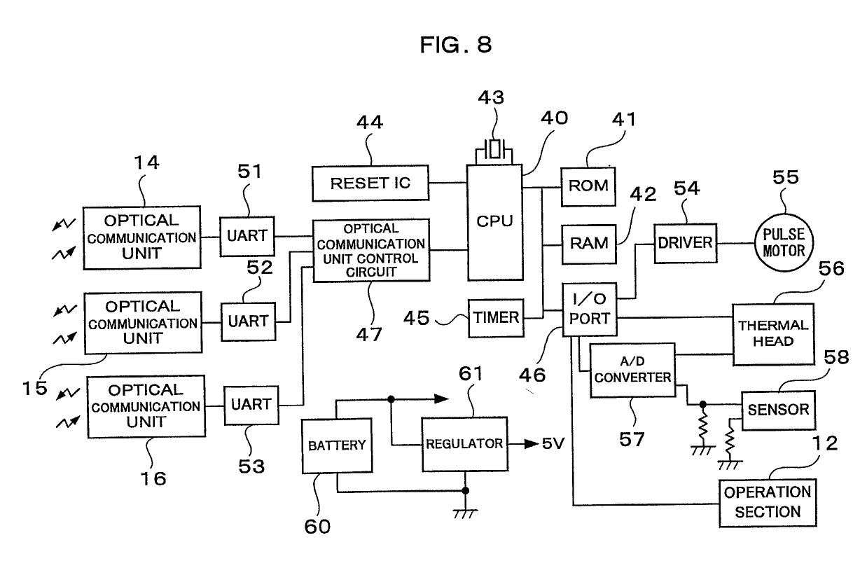

The construction of an electronic circuit inside the portable printer 1 is described with reference to FIG. 8.

A CPU 40 is a central processing unit for generally controlling the whole portable printer 1, and constitutes a microcomputer together with a ROM 41 serving as a program memory and a RAM 42 serving as a data memory. Further, a liquid crystal oscillator 43 for generating a clock pulse, a reset IC 44, a timer 45, an I/O port 46 and an optical communication unit control circuit 47 are respectively connected to the CPU 40.

The first optical communication unit 14, second optical communication unit 15 and third optical communication unit 16 are connected to the optical communication unit control circuit 47 which is an optical communication control means by way of universal asynchronous receiver/transmitters (UARTs) 51, 52 and 53. The UARTs 51, 52 and 53 are known circuits for processing data transmitted through optical communication (infrared-ray communication system).

The optical communication unit control circuit 47 renders first one of the three optical communication units, e.g., the first optical communication unit 14 to be in a data reception standby state while refusing data from the remaining other optical communication units 15, 16 so that three optical communication units do not receive data at the same time.

Upon lapse of a fixed time, the optical communication unit control circuit 47 disables the first optical communication unit 14 which is at present in a data reception standby state to receive data, and switches a subsequent second optical communication unit 15 to be rendered in a data reception standby state.

In such a manner, the optical communication unit control circuit 47 renders subsequently only one of the plurality of optical communication units to be in a data reception standby state while disabling the remaining other optical communication units to receive the data so that plurality of optical communication units do not receive data at the same time. That is, the optical communication unit control circuit 47 switches the optical communication units and effects sweep. If it is found that one of the optical communication units in a data reception standby state once receives data and effects optical communication between itself and the data output device, transmission and reception of data is effected continuously by only one of the optical communication units.

It is a manner of course that, in such a case, data is not received by the remaining other optical communication units or even if data is received by them, it is ignored.

With the operation of the optical communication unit control circuit 47, even if data is accidentally transmitted by a plurality of data output devices, it is possible to prevent the occurrence of a problem that such data is received by a plurality of optical communication units in duplication, causing erroneous data.

As mentioned in the foregoing, the optical communication unit control circuit 47 renders first one of the plurality of the optical communication units 14, 15 and 16 to be in data reception standby state while disabling remaining other two optical communication units to receive the data. The optical communication unit control circuit 47 may also interrupts the supply of power to the optical communication units other than the optical communication unit which was rendered in a data reception standby state, while switching the optical communication units to be rendered in a data reception standby state, thereby rendering the portable printer 1 in a power saving mode.

With the foregoing operation of the optical communication unit control circuit 47, there are advantageous effects that the portable printer 1 does not waste power, and a battery driven portable printer can be used for a long period of time when it is charged once. The reason is that an optical communication unit consumes a current of several mA even in a data reception standby state.

A driver 54, a thermal head 56, an A/D converter 57 and the operation section 12 are respectively connected to the I/O port 46. Further, a pulse motor 55 is connected to the driver 54 while a thermistor (not shown) for detecting a temperature of the thermal head 56 and a paper sensor 58 are respectively connected to the A/D converter 57. The operation section 12 comprises an LED or a liquid crystal display (LCD) for indicating an operation state and several operation keys.

The pulse motor 55 is a motor for driving a paper feed mechanism and constitutes a printing mechanism together with the thermal head 56 for effecting thermal printing on paper fed by the paper feed mechanism.

An output voltage of a battery 60 is regulated by a regulator 61 and supplied to the thermal head 56 and the driver 54. Although the battery 60 serves as a power supply to supply power to the CPU 40 and respective constituent elements of the electronic circuit, the illustration of a power supply circuit of the battery 60 is omitted.

With the above described embodiment, although three optical communication units are provided on different faces of the case 11, the number of the optical communication unit may be at least two, and hence it is needless to say to provide four optical communication units or more.

As mentioned in detail above, since the portable printer of the invention has at least two optical communication units on the different faces of the outer surface of the case thereof, optical transmission and reception of data can be effected with ease without operating the data output device unnaturally such that it is put over the portable printer perpendicularly, by selectively using a plurality of optical communication units even if the portable printer is carried on a user's waist or placed on a desk, thereby enhancing convenience of use of the portable printer.

What is claimed is:

1. A portable printer provided with optical communication units for effecting optical transmission and reception of data between itself and a data output device such as a handy terminal and a hand-held personal computer and printing data received by the optical communication units on paper, wherein the optical communication units are provided on different faces of an outer surface of the portable printer at two or more spots thereof.

2. The portable printer according to claim 1, wherein the optical communication units provided at two or more spots are mounted on a single printed-circuit board, respectively.

3. The portable printer according to claim 1, further comprising optical communication unit control means for giving a priority to one optical communication unit which first received data among the optical communication units provided at two or more spots, then refusing data from remaining other optical communication units.

4. The portable printer according to claim 2, further comprising optical communication unit control means for giving a priority to one optical communication unit which first received data among the optical communication units provided at two or more spots, then refusing data from remaining other optical communication units.

5. The portable printer according to claim 1, further comprising optical communication unit control means for periodically subsequently switching the optical communication units provided at two or more spots so as to render only one optical communication unit among the optical communication units in a state to receive data, and after either of the optical communication units received data, the optical communication unit control means rendering the optical communication unit which received data in a state to receive data continuously.

6. The portable printer according to claim 2, further comprising optical communication unit control means which periodically subsequently switches the optical communication units provided at two or more spots so as to render only one optical communication unit among the optical communication units in a state to receive data, and after either of the optical communication units received data, the optical communication unit control means renders the optical communication unit which received data in a state to receive data continuously.

7. The portable printer according to claim 5, wherein the optical communication unit control means further comprising power saving means for interrupting the supply of a power to the optical communication units other than one optical communication unit which is rendered in a state to receive data.

8. The portable printer according to claim 6, wherein the optical communication unit control means further comprising power saving means for interrupting the supply of a power to the optical communication units other than one optical communication unit which is rendered in a state to receive data.
